(19) United States
(12) Patent Application Publication
(10) Pub. No.: US 2025/0244971 A1
(43) Pub. Date: Jul. 31, 2025

(54) PERFORMANCE OF A SYSTEM

(71) Applicant: Arm Limited, Cambridge (GB)

(72) Inventors: Milos PUZOVIC, Cambridge (GB); Crefeda RODRIGUES, Cambridge (GB); Fadi ARAFEH, Cambridge (GB)

(21) Appl. No.: 18/427,407

(22) Filed: Jan. 30, 2024

(51) Int. Cl. G06F 8/36

(52) U.S. Cl. CPC G06F 8/36

(57) ABSTRACT

Methods, systems, and non-transitory computer-readable storage media for training and implementing machine learning models to improve performance of a plurality of hardware types when performing at least one task. Training comprises determining profiling points associated with an operation and receiving training data such that the machine learning model is trained to determine a computational cost associated with performing the operation. Implementing the trained machine learning model comprises analyzing an operation and determining an associated computation cost, selecting a combination of functions to perform the operation based on the computation cost, and performing the selected combination of functions.

### BACKGROUND OF THE INVENTION

### Field of the Invention

The present invention relates to methods, systems and non-transitory computer-readable storage media for training and implementing a machine learning model to improve performance, more particularly improving the performance of software when performing at least one task when implemented on a specific hardware target.

### Description of the Related Technology

As computational tasks become more complex, traditional hardware can often struggle to efficiently perform the tasks. Tasks are traditionally comprised of multiple operations it is therefore desirable to enhance the efficiency and speed of performing those tasks. With the rise of the different hardware targets, it is important to ensure that this efficiency and speed are matched regardless of the hardware target.

### SUMMARY

According to a first aspect of the present invention, there is provided a method of training a machine learning model to improve performance of a plurality of hardware targets when performing at least one task, each task comprising a plurality of operations, the method comprising determining at least one profiling point associated with a given one of the plurality of operations; receiving, by the machine learning model, training data, the training data comprising a range of inputs; and training the machine learning model to minimize a cost associated with a given one of the plurality of hardware targets, for performing the plurality of operations based on the training data, and based on the given hardware target, wherein training the machine learning model comprises determining at least the cost of performing the given one of the plurality of operations, at the at least one profiling point.

According to a second aspect of the present invention, there is provided a method of improving performance of a plurality of hardware targets when performing at least one task, each task comprising a plurality of operations, the method comprising analyzing using a trained machine learning model, at least one of a combination of functions for performing a given one of the plurality of operations; determining a cost associated with a given one of the plurality of hardware targets, for each of the combination of functions based on at least the analysis using the trained machine learning model, and the given hardware target; selecting at least a combination of functions for performing the given operation based on the cost; and performing the selected combination of functions to perform at least one of the plurality of operations on the given hardware target.

According to a third aspect of the present invention, there is provided a system for improving performance of a plurality of hardware targets when performing at least one task, each task comprising a plurality of operations, the system comprising a machine learning processor configured to analyze, using at least one trained machine learning model, at least one of a combination of functions for performing a given one of the plurality of operations; a determination module for determining a cost associated with the given one of the plurality of hardware targets, for each of the combinations of functions based on at least the analysis using the trained machine learning model, and a given one of the plurality of hardware targets; a selection module for selecting at least a combination of functions for performing the given operation based on the cost; and a processor configured to process at least the given operation comprising the selected combination of functions.

According to a fourth aspect of the present invention, there is provided a non-transitory computer-readable storage medium comprising a set of computer-readable instructions stored thereon which, when executed by at least one processor are arranged to cause the at least one processor to determine at least one profiling point associated with a given one of the plurality of operations; receive, by the machine learning model, training data, the training data comprising a range of inputs; and train the machine learning model to minimize a cost associated with a given one of a plurality of hardware targets, for performing the plurality of operations based on the training data, and based on the given hardware target, wherein training the machine learning model comprises determining at least the cost of performing the given one of the plurality of operations, at the at least one profiling point.

According to a fifth aspect of the present invention, there is provided a non-transitory computer-readable storage medium comprising a set of computer-readable instructions stored thereon which, when executed by at least one processor are arranged to cause the at least one processor to analyze using a trained machine learning model, at least one of a combination of functions for performing a given one of the plurality of operations; determine a cost associated with a given one of a plurality of hardware targets, for each of the combination of functions based on at least the analysis using the trained machine learning model, and a given hardware target; select at least a combination of functions for performing the given operation based on the cost; and perform the selected combination of functions to perform the hardware on the given hardware target.

### BRIEF DESCRIPTION OF THE DRAWINGS

Further features will become apparent from the following description of examples, which is made with reference to the accompanying drawings.

FIG. 1 is a flowchart showing a method of training a machine learning model to improve the performance of software on the plurality of hardware targets when performing at least one task according to an example;

FIG. 2 is a flowchart showing a method of improving performance using a trained machine learning model, according to an example; and

FIG. 3 shows schematically a system for improving performance according to an example.

### DETAILED DESCRIPTION OF CERTAIN INVENTIVE EMBODIMENTS

Software is becoming increasingly complex and as a result, computations are becoming more resource-intensive, requiring software libraries which comprise multiple operations each configured to be undertaken on the same or different hardware targets. In addition, the number of software libraries is increasing which in turn results in the integration of a larger number of operations with each release. Each software library, and the operations contained within, may be tied to the specific hardware targets used to implement a given task. In addition to hardware optimizations, each software library may have different specializations for undertaking particular tasks, for example, one library may comprise code optimized for the fast computation of skinny matrices, whereas another software library may comprise code optimized for square matrices, but which as a result provides a poor performance for skinny matrices. It will be appreciated that other software libraries may have different optimizations/specializations.

Such software libraries may be used to implement complex operations, such as, but not limited to, machine learning applications for inference, which require the use of multiple software libraries during execution. As such, determining which software library to select is important when trying to maximize performance. This is further compounded by the ability to implement such operations on different hardware targets.

To determine the optimal software library to use, manual heuristics may be undertaken on a per-library and per-operation basis, however, this is not scalable due to the integration of large numbers of libraries, operations, and the optimizations which may be present with each new release of the library. Furthermore, as software libraries are configured to be implemented on increasingly large numbers of different hardware targets, the number of heuristics required to be undertaken is ever-increasing. In addition, when performing such manual heuristics, there is no consideration of the processing/computing cost associated with performing each of the operations and/or libraries. For example, any pre-processing or post-processing required for a particular software library or operations contained within a framework is not considered, and as such, the implementation of that library or operation may not, from a holistic point of view, be the most efficient method of performing a given computation.

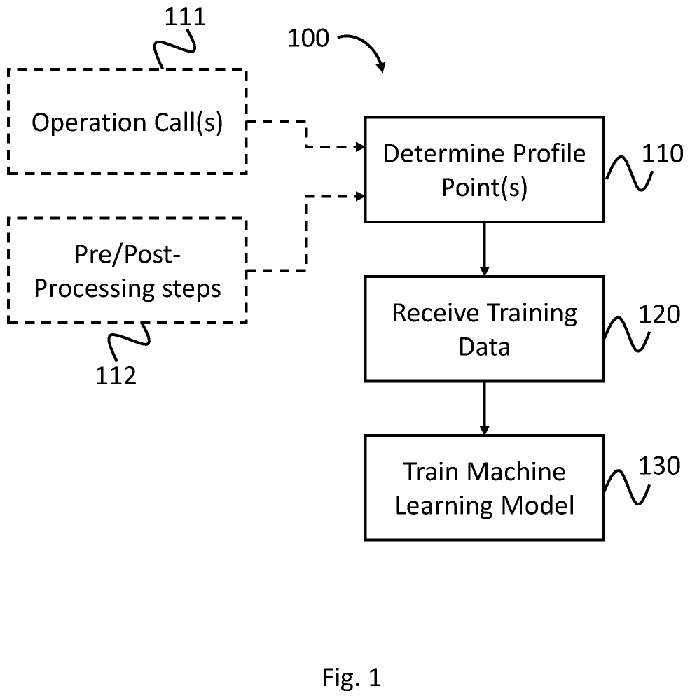

FIG. 1 is a flowchart showing a method 100 of training a machine learning model to improve the performance of hardware when performing at least one task which comprises a plurality of operations, such as the operations described above which are part of one or more software libraries. At step 110, at least one profiling point is determined. The profiling points as indicators as to where to determine one or more costs when training the machine learning model, as will be described below with reference to step 130. The profiling points may be determined based on a number of factors, including points in the performance of a task where calls to a software library and/or different operations are required. The profiling points may be based on the operations themselves, such as when calls for specific functions in a software library are required. These profiling points may also be determined based on the hardware target which may be used to perform the overall task. For example, on certain hardware different software libraries may be called at different times, and as such it may be desirable for a profiling point to be located at a position where a library may be called, even if it is not called when implemented on a particular hardware target. It will be appreciated that there are many different examples of where profiling points will be placed. By determining profiling points for assessing the cost, when training the machine learning model, as will be described in further detail below, the trained machine learning model can be used to analyze tasks and determine costs to be performed on multiple different hardware targets.

In some examples, the determination of the profiling points at step 110 may be based on other data. For example, where a task requires the implementation of one or more operation calls, operation call data 111 may be used to determine the profiling points. As described above, the operation call data may relate to calls for particular operations required when undertaking a task, and may, in some examples be hardware-dependent. The operation call data 111 may comprise a list of different operation calls which are to be, or can be, performed by different hardware targets. The operation call data 111 may comprise operations of a single or multiple software libraries including software libraries configured to provide operations to be performed on hardware targets different from the hardware which is undertaking the method 100 for training the machine learning model.

Similarly, the determination of profiling points at step 110 may also comprise receiving pre/post-processing data 112 relating to one or more pre- or post-processing steps required to be undertaken before or after the performance of an operation. The pre- or post-processing steps may comprise further operations and/or functions which need to be undertaken based on the ordering of the operations required to be performed when performing a given task. Such steps may include the reorganization of data in memory or the conversion of data from one format to another for example. It will be appreciated that any number of other pre- or post-processing steps may be indicated as potentially necessary when performing a given task, and therefore may be relevant to the determination of the profiling points. For example, where a given operation is selected when performing a task if that given operation requires data to be in a certain format, then a pre-processing step would be required to ensure that any data input into that operation is of the correct format. Similarly, an operation may output data in a particular format different from the data format of the task being performed. As such, it would be necessary to have a post-processing step scheduled after the operation to ensure that the data is in the correct format to be used by other operations of the task. Each of these pre- and post-processing steps will have an associated cost for performing the pre- and/or post-processing step on particular hardware targets, and therefore it will be relevant to take account of this cost when training the machine learning model, as will be described below.

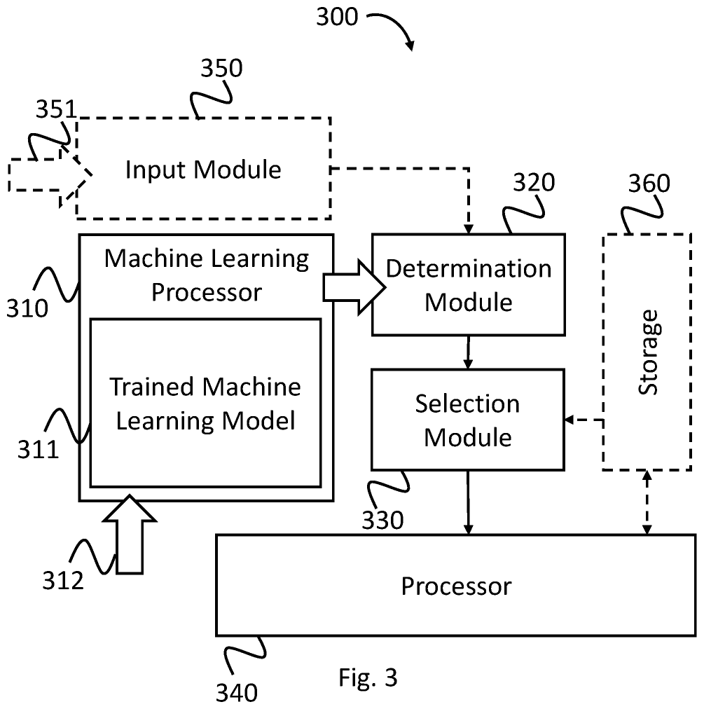

Following the determination of the profiling points, training data is received at step 120. The training data may be received from storage associated with a system, such as system 300 described below with reference to FIG. 3, and/or may be received from a remote storage in a server accessible over a network, such as the Internet. The training data may comprise data suited for training the machine learning model, for example, data which indicates given tasks, the cost for performing the task on a particular hardware type, and the constituent operations performed to undertake that task. For example, the training data may comprise entries for a plurality of hardware targets and operations (for performing the tasks), along with costs (e.g., times/hardware resource usage) associated with the implementation of different software libraries for the operation on each hardware target. The cost for performing the task on a particular hardware target may relate to the processing requirements and/or memory requirements for performing the task. It will be appreciated that other hardware resource usage may also be considered when specifying a particular cost for performing the task. More particularly, in some examples, the training data may comprise data relating to the performance of operations on multiple different hardware targets, thereby ensuring that the machine learning model can be trained to determine the computation cost of different operations on different hardware targets. In some examples, function inputs may also be provided to train the machine learning model, the functions inputs may be based on a statistically representative distribution of a given input to one or more tasks (or constituent functions/operations), thereby representing a multitude of potential inputs, enabling the machine learning model to be trained to determine more accurate costs. In other examples, the training data may also comprise labelled information regarding which pre- and/or post-processing steps are required for each operation and the associated costs.

Once the training data has been received, it is used to train the machine learning model at step 130. Training the machine learning model comprises determining at least a cost associated with performing each of the given operations of the task at, at least one of, the profiling points determined in step 110 described above. The cost for performing each of the operations may be associated with the functions required to perform each of the operations, the functions being calls to one or more software libraries. The machine learning model is trained to minimize the cost of performing the operation over a plurality of different hardware targets. The training of the machine learning model is based on the training data, which in some examples may also used to validate the accuracy of the trained model, where the training data is used to validate the accuracy of the trained machine learning model, the training data may be split such that a portion is used for training, e.g., 80%, and a portion is used for validation, e.g., 20%. In other examples, separate test data may be obtained and used to validate the accuracy of the trained model. The trained machine learning model may comprise at least one neural network, such as a feed-forward neural network, although it will be appreciated that the machine learning model may comprise any number of other types of neural networks.

By training the machine learning model in such a way, it may be used to determine the optimal performance for any operation on any hardware target by selecting a combination of functions to perform the operation based on the hardware target. The machine learning model can take into account complexities which would not necessarily be borne out when generating heuristics manually as described above and therefore enables the performance of the operation to be optimized for different hardware.

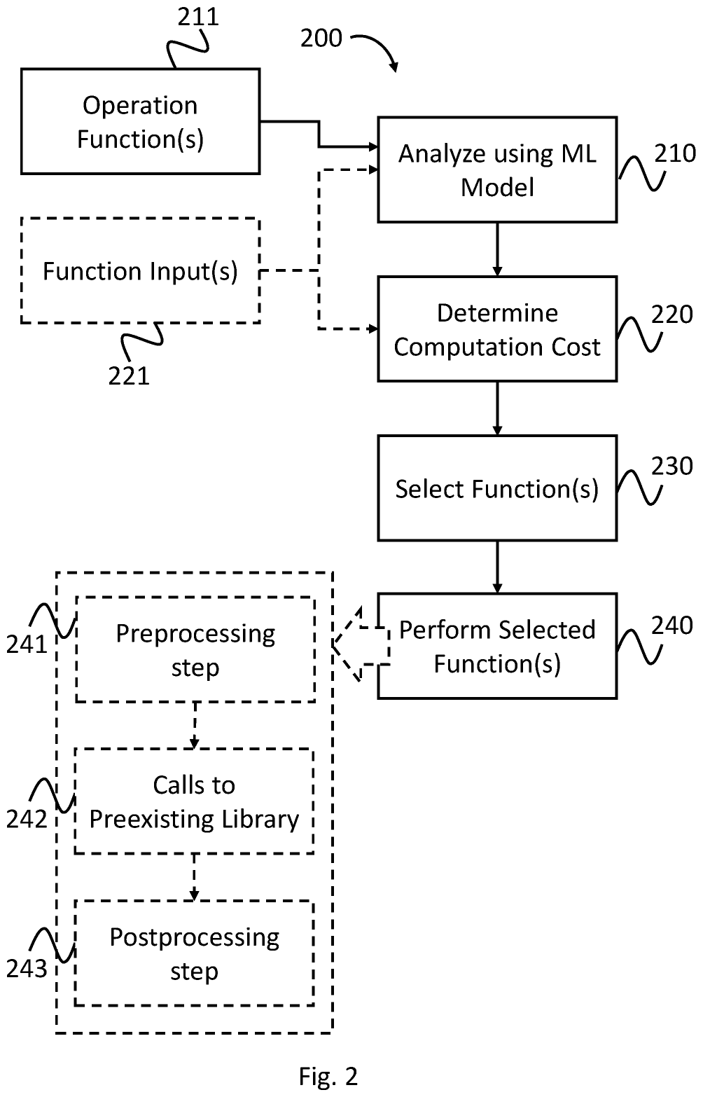

FIG. 2 is a flowchart showing a method 200 of improving the performance of a plurality of hardware targets when performing at least one task comprising a plurality of operations. As described above, it is desirable to optimize the performance of tasks on different hardware, where the tasks require the performance of operations, which may, in some examples form part of one or more software libraries. The trained machine learning model may be loaded into a device according to a particular hardware type. At step 210, the task is analyzed using a trained machine learning model, such as the machine learning model trained using method 100 described above in relation to FIG. 1. The machine learning model may comprise a plurality of different functions, including a neural network, such as a feed-forward neural network. The trained machine learning model is used to analyze the task, more particularly the operations of the task. The machine learning model is configured, as set out above, and is used to determine a set of functions for undertaking the operation such that the cost associated with performing the tasks is minimized. In some examples, the operation may comprise a given list of functions 211 which may be provided as an input to the machine learning model, in which case the machine learning model will analyze these functions and determine different options for calling the software libraries containing those functions or equivalent functions for different hardware targets. The combination of functions may therefore be adjusted and/or altered based on the analysis performed by the machine learning model. In some examples, more than one set of functions is output by the machine learning model, each of the combinations of functions leveraging different computing resources, for example, different software libraries. In some examples, function inputs 221 may also be input into the machine learning model. The function inputs 221 may be of any suitable type, however, in some examples, they may be based on a representation of data obtained from one or more tasks (or constituent functions/operations) being undertaken on the given hardware target.

Following the analysis, a cost associated with performing each of the combinations of functions is determined at step 220. This cost is based on the different combinations of functions provided by the analysis of the machine learning model, and in examples where pre- and post-processing steps are required, takes into account any additional overheads required to perform those steps. In addition to being based on the combination of functions determined based on the analysis by the machine learning model at step 210, the cost may also be determined based on one or more function inputs 221, which may be provided to the operation or each constituent function, such as the function inputs described above for use when analyzing the task at step 210.

Once the cost for performing each of the combination of functions has been determined, the combination of functions which are required to perform the operation is selected at step 230. The selected functions may be one of or a combination of different function groups/combinations indicated by the analysis undertaken at step 210 by the machine learning model. That is the selected combination is the combination of functions for a given operation, with an optimal cost for a given hardware target, wherein the hardware target is the selection of hardware (processor, memory, etc.) on which the operation is being performed. The functions are selected based on the cost at step 220 and may also comprise data relating to the cost required to perform any pre- or post-processing steps before performing any of the combinations of functions.

Next, the selected functions are then performed at step 240. Performing the selected combination of functions may include performing one or more pre-processing steps 241, in order to ensure that the data processed by the functions is in the correct format, and/or to perform any other processing required to ensure optimal performance of the functions. Similarly, performing the selected function may comprise calling 242 one or more preexisting software libraries which comprise a plurality of different functions for performing particular tasks on different hardware targets, or being specialized for a particular hardware target. Similarly, following the execution of the function, one or more post-processing steps 242 may be performed. The post-processing steps may comprise a number of other functions to ensure the output of any preceding function(s)-such as those in a preexisting software library-is in the correct format, or in a format which ensures optimal performance of any subsequent function.

FIG. 3 shows schematically a system 300 for improving hardware performance, such as by implementing method 200 described above.

System 300 comprises a machine learning processor 310, which is configured to implement a trained machine learning model 311, such as the machine learning model trained in accordance with method 100 described above in relation to FIG. 1. In some examples, the machine learning processor 310 may be configured to train the machine learning model 311 itself, and as such configured to implement method 100 described above. The machine learning processor may be any suitable processor configured to implement the machine learning model 311, for example, the machine learning processor 310 may be a neural processor or be a neural processing unit comprised within another larger processor, such as a central processing unit. The machine learning model 311 is arranged to receive an operation 312 to be performed and is configured, as described above, to analyze the operation to determine at least one optimal combination of functions to implement that operation.

System 300 also comprises a determination module 320 configured to determine the costs associated performing each of the combinations of functions provided by the machine learning processor 310 on a particular hardware target. In addition, in some examples, the determination module also receives data from an input module 350 which receives input data 351. The input data 351 may be data obtained from one or more tasks being executed on the hardware target. In such examples, the determination module 320 determines the costs for performing the combination of functions on the input data, across multiple different hardware targets. As with the machine learning model 310, the determination module may be part of a larger processing/hardware unit.

Similarly, the selection module 330 may be part of a larger processing/hardware unit. The selection module 330 is configured to select one or more of the combinations of functions whose cost has been determined by the determination module 320. The selection of the combination of functions may be based on a number of factors, and take into account the determined cost, as well as whether other pre- and/or post-processing steps are required to be undertaken when implementing the selected combination of functions. In addition, the selection of the combination of functions may be based on the availability of one or more preexisting software libraries in storage 360 associated with the system 300, as will be described in further detail below.

System 300 also comprises a processor 340 for performing the selected combination of functions configured to implement the task in an efficient manner. The selected combination of functions may be selected based on the hardware target, such as the type of the processor 340 and/or available memory/storage. The processor 340 may be any suitable processor, such as a central processing unit, a graphics processing unit, or a neural processing unit. The processor 340 may be dependent on the implementation of system 300, such as being specialized for performing particular types of tasks/operations, such as tasks associated with driverless vehicles, image/video processing applications, such as image enhancement, or edge and feature detection.

The system 300 may also comprise a storage device 360 for storing data for use by the other system components 310, 320, 330, 340, 350. The storage 360 may be configured to store at least one preexisting software library comprising a plurality of functions for use in the performance of different operations on different hardware targets. In some examples, a memory access controller may also be provided which is connected to the memory. The memory access controller may comprise a dynamic memory controller. The memory controller is configured to manage the flow of data going to and from the memory. The memory may, for example, comprise a magnetic or optical disk and disk drive or a solid-state drive (SSD) or non-volatile RAM (NVRAM). In some examples, the memory comprises a synchronous dynamic random-access memory (SDRAM). For example, the memory may comprise a double data rate synchronous dynamic random-access memory (DDR-SDRAM).

One or more of the machine learning processor 310, determination module 320, the selection module 330, the processor 340, the input module 350, and/or the storage 360, as well as other components (not shown), may be interconnected, for example using a system bus, although it will be appreciated some components 310, 320, 330, 340, 350, 360 of the system 300 may be directly connected to one another such that the output of one component is connected directly to the input of another component in a pipeline. This allows data to be transferred between the various components. The system bus may be or include any suitable interface or bus. For example, an ARM® Advanced Microcontroller Bus Architecture (AMBAR) interface, such as the Advanced eXtensible Interface (AXI), may be used.

It will be appreciated that the system 300 may be a system on chip (SOC) specifically designed to undertake a specific task, such as, as part of an optimization application.

Examples of the above-described methods may be provided by a non-transitory computer-readable storage medium comprising a set of computer-readable instructions stored thereon which, when executed by at least one processor, cause the at least one processor to perform the method. In other words, examples of the above-described methods may be provided by a computer program product. The computer program product can be provided by dedicated hardware or hardware capable of running the software in association with the appropriate software. When provided by a processor, these operations can be provided by a single dedicated processor, a single shared processor, or multiple individual processors that some of the processors can share. Moreover, the explicit use of the terms “processor” or “controller” should not be interpreted as exclusively referring to hardware capable of running software, and can implicitly include, but is not limited to, digital signal processor “DSP” hardware, GPU hardware, NPU hardware, read-only memory “ROM” for storing software, random access memory “RAM”, NVRAM, and the like. Furthermore, implementations of the present disclosure can take the form of a computer program product accessible from a computer-usable storage medium or a computer-readable storage medium, the computer program product providing program code for use by or in connection with a computer or any instruction execution system. For the purposes of this description, a computer-usable storage medium or computer-readable storage medium can be any apparatus that can comprise, store, communicate, propagate, or transport a program for use by or in connection with an instruction execution system, apparatus, or device. The medium can be an electronic, magnetic, optical, electromagnetic, infrared, or semiconductor system or device, or propagation medium. Examples of computer-readable media include semiconductor or solid-state memories, magnetic tape, removable computer disks, random access memory “RAM,” read-only memory “ROM,” rigid magnetic disks, and optical disks. Current examples of optical disks include compact disk-read-only memory “CD-ROM,” optical disk-read/write “CD-R/W,” Blu-Ray, and DVD.

The above example implementations are to be understood as illustrative examples of the present disclosure. Further implementations are also envisaged. For example, implementations described in relation to a method may also be implemented in a computer program product, in a computer-readable storage medium, in a system, or in a device. It is, therefore, to be understood that a feature described in relation to any one implementation may be used alone, or in combination with other features described, and may also be used in combination with one or more features of another of the implementation, or a combination of other the implementations. Furthermore, equivalents and modifications not described above may also be employed without departing from the scope of the disclosure, which is defined in the accompanying claims.

What is claimed is:

1. A method of training a machine learning model to improve performance of a plurality of hardware targets when performing at least one task, each task comprising a plurality of operations, the method comprising:
determining at least one profiling point associated with a given one of the plurality of operations;
receiving, by the machine learning model, training data, the training data comprising a range of inputs; and
training the machine learning model to minimize a cost associated with a given one of the plurality of hardware targets for performing the plurality of operations based on the training data, and based on the given one of the plurality of hardware targets,
wherein training the machine learning model comprises determining at least the cost of performing the given one of the plurality of operations, at the at least one profiling point.

2. The method of training a machine learning model according to claim 1, further comprising determining a plurality of profiling points based on one or more calls in at least one of the plurality of operations, the calls being made to at least one preexisting software library.

3. The method of training a machine learning model according to claim 2, further comprising analysing a given operation of the plurality of operations to determine any pre- or post-processing steps required when calling the at least one preexisting software library associated with the given operation, when implemented on at least one of the plurality of hardware targets.

4. The method of training a machine learning model according to claim 3, wherein minimizing the cost associated with the performance of the plurality of operations based on the training data comprises selecting at least one of the preexisting software libraries based on a further cost associated with any of the pre- or post-processing steps.

5. The method of training a machine learning model according to claim 1, wherein the range of inputs is a statistically representative distribution.

6. The method of training a machine learning model according to claim 1, wherein the machine learning model comprises at least a feed-forward neural network.

7. A method of improving performance of a plurality of hardware targets when performing at least one task, each task comprising a plurality of operations, the method comprising:
analyzing using a trained machine learning model, at least one of a combination of functions for performing a given one of the plurality of operations;
determining a cost associated with a given one of the plurality of hardware targets, for each of the combination of functions based on at least the analysis using the trained machine learning model, and the given hardware target;
selecting at least a combination of functions for performing the given operation based on the cost; and
performing the selected combination of functions to perform at least one of the plurality of operations on the given hardware target.

8. The method of improving performance of a plurality of hardware targets according to claim 7, wherein determining the cost for each of the combination of functions is further based on an input to at least one of the plurality of operations.

9. The method of improving performance of a plurality of hardware targets according to claim 7, wherein performing the selected combination of functions comprises calling at least one preexisting software library associated with the given operation, the at least one preexisting software library comprising a plurality of functions.

10. The method of improving performance of a plurality of hardware targets according to claim 9, further comprising performing at least one pre-processing step before calling the at least one preexisting software library associated with the given operation.

11. The method of improving performance of a plurality of hardware targets according to claim 7, wherein the trained machine learning model comprises at least a feed-forward neural network.

12. The method of improving performance of a plurality of hardware targets according to claim 7, wherein the trained machine learning model is trained using the method of claim 1.

13. The method of improving performance of a plurality of hardware targets according to claim 7, further comprising loading the machine learning model into a device according to a given hardware target.

14. A system for improving performance of a plurality of hardware targets when performing at least one task, each task comprising a plurality of operations, the system comprising:
a machine learning processor configured to analyze, using at least one trained machine learning model, at least one of a combination of functions for performing a given one of the plurality of operations;
a determination module for determining a computation cost for each of the combinations of functions based on at least the analysis using the trained machine learning model, and a given one of the plurality of hardware targets;
a selection module for selecting at least a combination of functions for performing the given operation based on the cost; and
a processor configured to process at least the given operation comprising the selected combination of functions.

15. The system for improving performance of a plurality of hardware targets according to claim 14, further comprising an input module configured to receive at least data for processing by the given operation.

16. The system for improving performance of a plurality of hardware targets according to claim 14, wherein the determination module is configured to determine the cost based on the data received by the input module.

17. The system for improving performance of a plurality of hardware targets according to claim 14, further comprising storage for storing at least one preexisting software library associated with at least the given operation, the at least one preexisting software library comprising a plurality of functions.

18. The system for improving performance of a plurality of hardware targets according to claim 17, wherein the processor is configured to call at least one of the preexisting software libraries based on the determined cost.

19. The system for improving performance of a plurality of hardware targets according to claim 17, wherein the processor is further configured to perform at least one pre-processing step before calling the at least one preexisting software library associated with the given operation.

20. A non-transitory computer-readable storage medium comprising a set of computer-readable instructions stored thereon which, when executed by at least one processor are arranged to cause the at least one processor to:
determine at least one profiling point associated with a given one of the plurality of operations;
receive, by the machine learning model, training data, the training data comprising a range of inputs; and
train the machine learning model to minimize a cost associated with a given one of a plurality of hardware targets, for performing the plurality of operations based on the training data, and based on the given hardware target,
wherein training the machine learning model comprises determining at least the cost of performing the given one of the plurality of operations, at the at least one profiling point.

21. A non-transitory computer-readable storage medium comprising a set of computer-readable instructions stored thereon which, when executed by at least one processor are arranged to cause the at least one processor to:
analyze using a trained machine learning model, at least one of a combination of functions for performing a given one of the plurality of operations;
determine a cost associated with a given one of a plurality of hardware targets, for each of the combination of functions based on at least the analysis using the trained machine learning model, and the given hardware target;
select at least a combination of functions for performing the given operation based on the cost; and
perform the selected combination of functions to perform the hardware on the given hardware target.
